(19) United States
(12) Patent Application Publication
(10) Pub. No.: US 2002/0026719 A1
(43) Pub. Date: Mar. 7, 2002

(54) Can opening apparatus

(76) Inventor: Yu Wang, Lu Zhou (CN)

Correspondence Address: Lance Vietzke, c/o Dorsey & Whitney, Suite 300 South, 1001 Pennsylvania Ave., N.W., Washington, DC, 20004, US

(21) Appl. No.: 09/769,389

(22) Filed: Jan. 26, 2001

(30) Foreign Application Priority Data
Sep. 7, 2000 (CN) 00244389.9

(51) Int. Cl. B67B 7/46

(52) U.S. Cl. 30/417

(57) ABSTRACT

Apparatus for opening a can includes an upwardly extending guide column, an upper platform assembly which includes an upper platform slidably mounted to the column for guided movement along the column, and a counterbalance mechanism connected to the upper platform for neutralizing the weight of the upper platform assembly. As well, the upper platform assembly includes a cutting mechanism carried by the upper platform for opening the can when the can is aligned beneath the upper platform in a can opening position. The cutting mechanism includes a rotatable circular cutting blade for cutting a seam wall of a rim of the can, and a rotatable traction wheel.

### FIELD OF THE INVENTION

This invention relates to can opening apparatus of the type which includes a rotatable circular cutting blade for cutting a seam wall of the rim of a can and a rotatable traction wheel.

### BACKGROUND TO THE INVENTION

The prior art is replete with can openers having a rotatable cutting blade and rotatable traction wheel designed to engage and cut the rim of a can. However, existing designs are generally not well adapted to handle larger sized, heavy cans using this cutting mechanism.

Typically, the cutting mechanism can be subject to stresses and uneven forces that lead to relatively rapid wear and tear and, in some cases, breakage. Further, it can be difficult to clamp and hold a can in a stable, controlled manner during the cutting process—thus leading to unexpected slippage or drop-off.

Generally, there is a need for can opening apparatus which not only avoids such disadvantages but also which is reliable and easy to use on a continuous basis within commercial and institutional working conditions. A primary object of the present invention is to provide new and improved can opening apparatus which address this need.

### SUMMARY OF THE INVENTION

In a broad aspect of the present invention there is provided apparatus for opening a can, the apparatus comprising an upwardly extending guide column, an upper platform assembly which includes an upper platform slidably mounted to the column for guided movement along the column, and a counterbalance mechanism connected to the upper platform for neutralizing the weight of said upper platform assembly. As well, the upper platform assembly includes a cutting mechanism carried by the upper platform for opening the can when the can is aligned beneath the upper platform in a can opening position. The cutting mechanism includes a rotatable circular cutting blade for cutting a seam wall of a rim of the can, and a rotatable traction wheel.

In a preferred embodiment, the counterbalance mechanism comprises a spring tension weight balancer attached to the upper platform, and a retractable riser cable extending upwardly from said balancer to a fixed hanger. The fixed hanger may be conveniently fixed at the top end of the guide column.

The cutting blade is preferably positioned so as to cut an outer seam wall of the can's rim. This avoids the possibility that the cutting blade may otherwise contact and contaminate food within the can, and reduces the risk that metal shavings will drop into the can.

To provide a firmer grip or clamp on the can while it is being opened, the traction wheel preferably includes teeth for applying traction to both top and side surfaces of the can's rim.

Advantageously, the plane of rotation of the cutting blade may be tilted with respect to the plane of rotation of the traction wheel. This enables the cutting blade not only to perform its cutting function but also to urge the separation the vertical separation of the rim from the can during the cutting process. Further, it serves to pull the upper platform assembly towards the can such that the traction wheel moves into full traction engagement with the can's rim.

Preferably, the guide column extends upwardly from a lower platform which also provides underlying support for any can to be opened. To minimize friction between the can and the underlying support, the lower platform preferably has raised ridges rather than an entirely flat surface on which the bottom of the can is held or rested. To further advantage, the apparatus may include a locating keeper extending above the lower platform for holding a can from a side of the can, and for assisting to properly align the can beneath the cutting mechanism. As well the apparatus may include rotatable rollers mounted on the bottom of the upper platform to hold the top of the can with minimal friction resistance.

The foregoing and other features of the invention will now be described in more detail with reference to the embodiment shown in the drawings.

### BRIEF DESCRIPTION OF THE DRAWINGS

FIG. 1 is a side elevation view, partially cut-away and partially sectioned, of can opening apparatus in accordance with the present invention.

FIG. 2 is a front elevation view, partially cut-away and partially sectioned, of the apparatus shown in FIG. 1.

FIG. 3 is a cross-sectional view taken along line A-A in FIG. 1.

FIG. 4 is a cross-sectional view taken along line B-B in FIG. 1.

FIG. 5 is an enlarged view showing a can rim in a cutting position between a circular cutting blade and a rotatable traction wheel forming part of the apparatus shown in FIG. 1.

FIG. 6 is a perspective view of the traction wheel shown in FIG. 5.

FIG. 7 is an enlarged view of a portion of the apparatus as shown in FIG. 1.

### DETAILED DESCRIPTION OF PREFERRED EMBODIMENT

The can opening apparatus shown in the FIGURES is electrically driven and includes an upper platform assembly generally designated 100, a lower platform 28, a guide column 24 extending upwardly from the lower platform, and a weight counterbalancing mechanism described below.

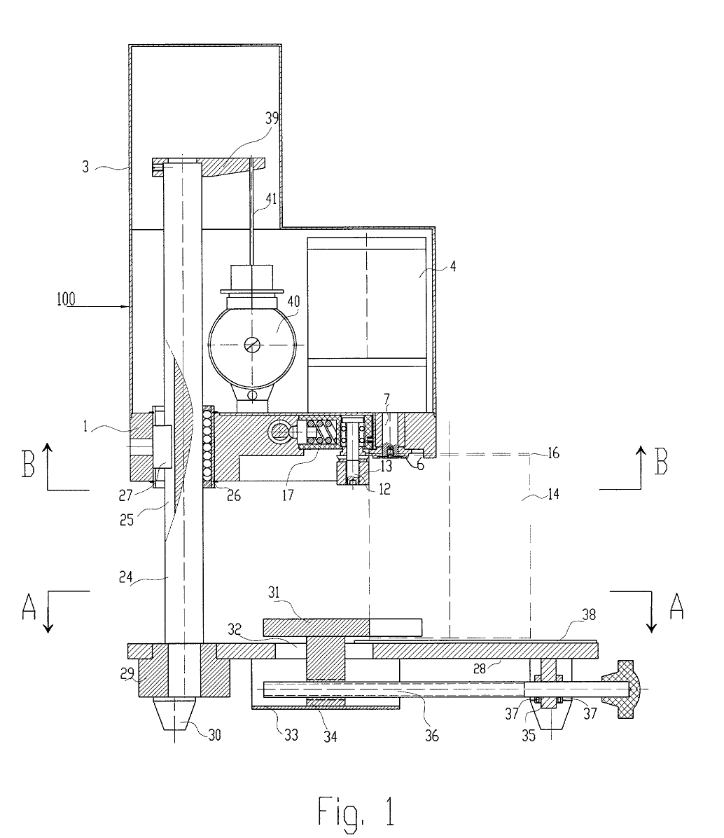

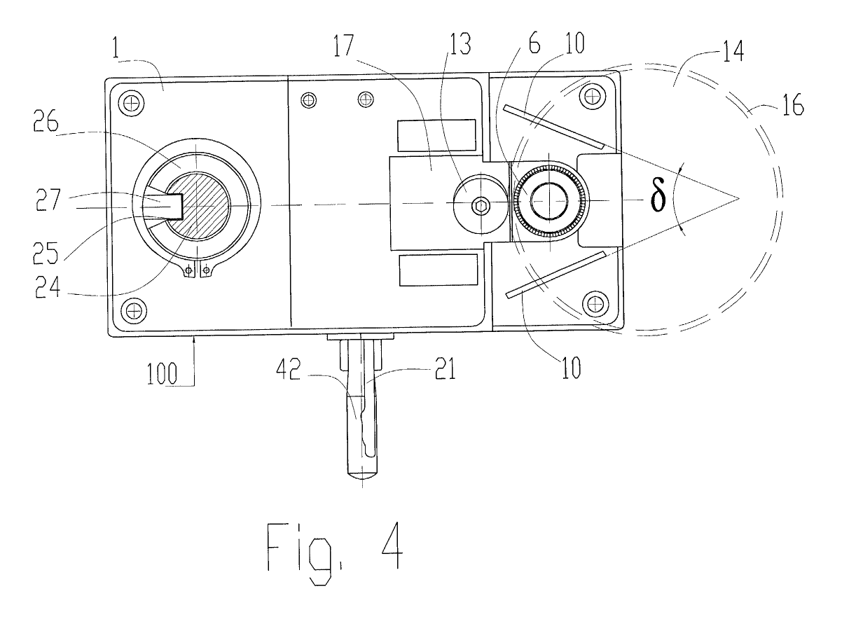

Lower platform 28 is generally planar and is supported on four abutments 30. Upper platform assembly 100 includes an upper platform 1 mounted to column 24 for guided movement along the column to a desired position, and a cutting mechanism carried by upper platform 1. Column 24 is firmly fixed at its lower end in an axle bushing 29 mounted towards the rear of lower platform 28. A linear motion bearing 26 is attached towards the rear of upper platform 1, and column 24 is slidingly fitted through the bearing to enable upper platform assembly 100 to move up and down the column with minimal friction. As best seen in FIGS. 1 and 4, a locating stud 27 fitted to upper platform mates or keys with a corresponding longitudinal groove 25 on the rear side of column 24. The movement of upper platform assembly 100 on column 24 is thereby restrained to vertical up and down movement. Rotational movement is not permitted. Of course, it will be understood that if the cross-sectional shape of column 24 was square or some other non-cylindrical shape, then the need for a locating stud such as stud 27 could be avoided.

In the FIGURES, a can 16 having a rim 14 is shown by way of example with dash-double dot lines. The cutting mechanism carried by upper platform 1 is adapted for opening such a can when the can placed beneath the upper platform in a suitable can opening position. The mechanism includes a circular cutting blade 11 and a traction wheel 6 which can be moved towards each other to clamp rim 16 of can 14. Other components described below also are carried by upper platform 1.

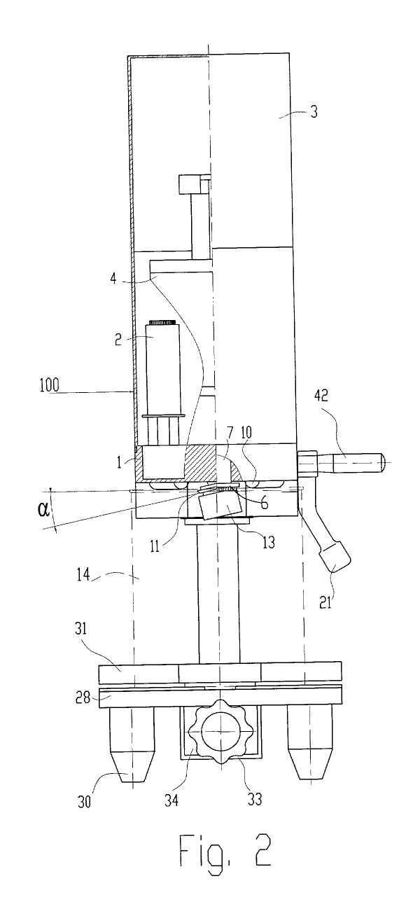

In more detail, upper platform 1, carries an electrical motor assembly 4 (see FIG. 12) mounted towards the front of the platform and conventional electronic motor control components 2 (see FIG. 2). Motor assembly 4 includes a reversible speed motor, a downwardly extending output drive shaft 7, and a gear reduction (not shown) coupling the drive shaft of the motor (not shown) to output shaft 7. Suitable motors, motor control components, and gear reductions are available from a variety of commercial sources. In the present embodiment, a motor running at 220 volts, 40 watts, with a gear reduction such that output shaft 7 rotates at about 30 rpm during operation has been found to work well. The motor is preferably a reversible speed motor because an occasional jam may occur. In such cases, a jam may be released more easily by reversing the motor.

A hollowed cover 3 covers the upper part of platform 1, including motor assembly 4 and motor control components 2. It will be understood that cover 3, motor assembly 4 and motor control components 2 are all part of upper platform assembly 100.

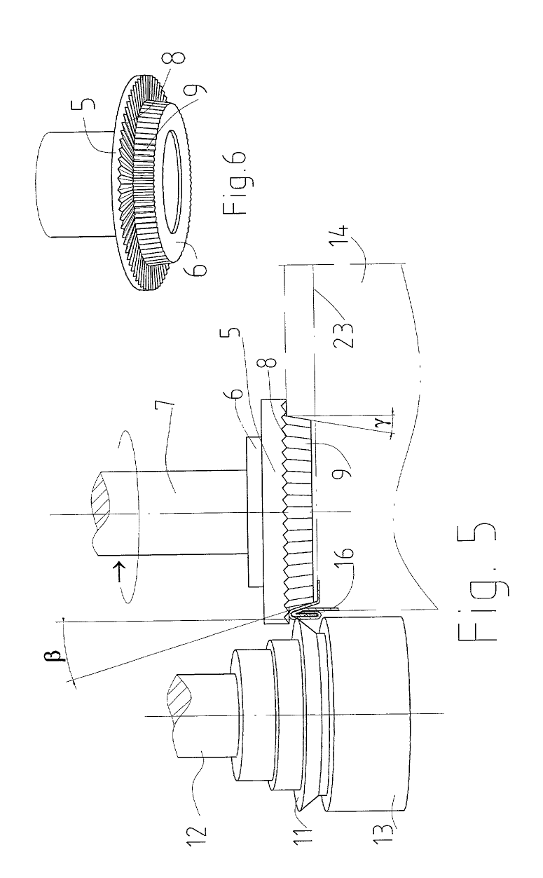

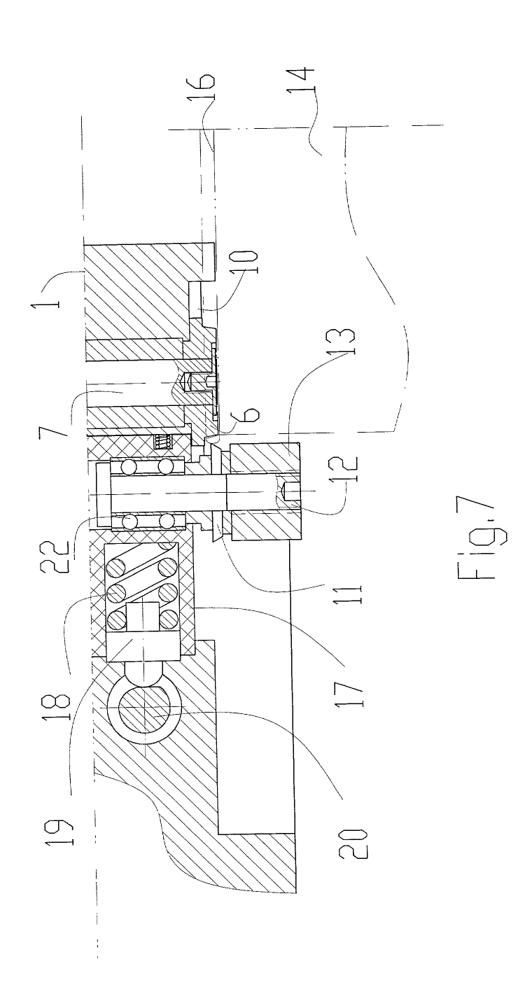

As best seen in FIG. 5, traction wheel 6 is mounted at the lower end of output drive shaft 7. Thus, wheel 6 rotates with the speed of shaft 7. The lower part of the traction wheel 6 is a circular truncated cone (frustroconical) on which longitudinal teeth 9 are evenly distributed. All extension lines of teeth 9 form an angle γ (preferably about 5 to 7 degrees) with the main axis of traction wheel 6. This angle is smaller than the angle β which is formed between the inner face of can rim 16 and the main axis of the can body 14 for most currently available cans. Typically, the angle β of most cans is about 8 to 10 degrees.

The upper part of traction wheel 6 includes an annular circular flange 5 having evenly distributed radially extending transverse teeth 8. All radial extension lines of teeth 8 pass through the center axis of the traction wheel. The number of longitudinal teeth 9 is the same as the number of transverse teeth 8 and each longitudinal tooth 9 joins a corresponding transverse tooth 8.

Cutting blade 11 is mounted on a rotatable spindle 12 and is shaped as an annular circular disk with one larger diameter surface and a smaller diameter surface. A primary locating stopper 13 is mounted under blade 11.

A guide way is formed within upper platform 1, behind traction wheel 6, and extends rearwardly towards the back of platform 1. A slide block 17 is positioned in the guide way. The cross-sectional shape of the guide way matches the cross-sectional shape of slide block 17 to permit block 17 to reciprocate in the guide way. Supported by ball bearings 22 to permit free rotation, the upper portion of spindle 12 is carried within slide block 17.

As best seen in FIG. 7, a compression spring 18 is positioned within slide block 17. It is seated at one end on a spring saddle 19 and at its other end bears against an inner wall of slide block 17. The outer end of saddle 19 is biased by the spring against the surface of a camshaft 20 which extends through a hole in platform 1. Lever handle 21 shown in FIGS. 2 and 4 is mounted on an end of camshaft 20 outside the hole in platform 1, and is used to manually rotate camshaft 20 within the hole against the bias of spring 18.

With respect to the cutting mechanism, it will be seen in FIG. 2 that a cutting angle α is formed between the plane of cutting blade 11 (viz. the plane of rotation of blade 11) and the plane of flange 5 (viz. the plane of rotation) of traction wheel 6. The presence of this angle is also reflected in FIG. 5 where the upper flat surface of cutting blade 11 is forwardly tilted and is thus visible, and where the upper flat surface of flange 5 extends in a horizontal plane and is thus invisible.

The provision of angle α, which preferably is about 13 to 15 degrees, enables cutting blade 11 not only to laterally cut through the rim of a can but also to urge the vertical separation of the rim from the remainder of the can.

When opening a can 14, can rim 16 is placed between traction wheel 6 and cutting blade 11. On pushing lever handle 21 down, camshaft 20 rotates and pushes saddle 19 against the bias of spring 18. In turn, spring 18 pushes against the inner wall of slide block 17, thereby moving the block with cutting blade 11 in the direction of the outer wall of the rim. Ultimately, blade 11 moves into abutment with the outer wall of the rim. Continued lever movement then pushes both slide block 17 and rim 16 laterally until the inner face of the rim abuts teeth 9 of traction wheel 6. Rim 16 then becomes clamped between cutting blade 11 and traction wheel 6.

To provide a more reliable hold on a can such as can 14, the present apparatus includes a number of features. A pair of rotatable rollers 10 is mounted on the bottom of upper platform 1 to hold the top of the can; two raised ridges 38 are provided on the upper surface of lower platform 28 to hold the bottom of the can; and, a locating keeper 31 is provided to hold the can from the side of the can.

In more detail, and as best seen in FIGS. 2 and 4, rollers 10 are symmetrically positioned on opposed sides of traction wheel 6. They form an angle δ (preferably about 50 degrees) with respect to each other, the angle opening rearwardly towards the back of platform 1. When holding the top of a can while the can is being opened, the rollers will rotate with the can thereby offering minimal resistance to rotation of the can.

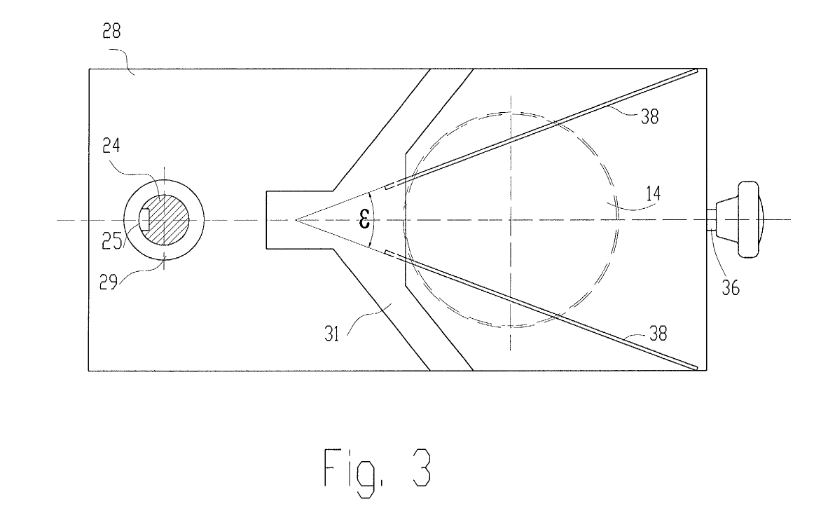

As best seen in FIG. 3, ridges 38 are symmetrically positioned on opposed sides of the longitudinal centerline of platform 28. They form an angle ε (preferably about 50 degrees) with respect to each other, the angle opening forwardly towards the front of platform 28. Ridges 38 serve to provide a reduced contact surface area between the bottom of a can and the underlying support for the can. Consequently, there will be reduced friction on the bottom of the can while the can rotates as it is being opened.

Locating keeper 31 not only serves to hold a can from its side but also assists to properly align a can beneath the cutting mechanism. It has a generally Y-shaped configuration and extends in a horizontal plane slightly above the upper surface of lower platform 28. As seen in FIG. 3, the arms of the Y-shape are symmetrically positioned on opposed sides of the longitudinal centerline of platform 28 and open towards the front of the platform. Preferably, the angle between the arms is about 130 degrees. As best seen in FIG. 1, keeper 31 is mounted atop a support block 34 which extends downwardly through hole 32 in platform 28. The bottom of block 34 rests atop the bottom wall of a support rack 33 which is fixedly attached to the underside of platform 28. A support lug 35, positioned towards the front underside of platform 28, extends downwardly from the platform.

A screw stem adjustable rod 36 with a manual turning knob at its outer end passes through a guide hole in lug 35 and extends to threadingly engage block 34. The lengthwise position of rod 36 in lug 35 is secured by locking rings 37 on either side of lug 35. By turning the knob, block 34 together with keeper 31 may be moved forwardly and backwardly (viz. left to right or right to left in FIG. 1) to make adjustment for either a straight can or a tapered can.

As initially noted above, the can opening apparatus shown in the FIGURES also includes a weight counterbalancing mechanism. The general purpose of the mechanism is to neutralize the weight of upper platform assembly 100, that weight including not only the weight of upper platform 1 but also the weight of components carried by upper platform 1.

More particularly, the counterbalance mechanism includes a fixed hanger 39 attached to the top end of guide column 24, and a spring tension weight balancer 40 attached to the upper surface of upper platform 1. A flexible stainless steel cord or riser cable 41 interconnects hanger 39 and balancer 40 to form a spring-tension mechanism that serves to neutralize the weight of upper platform assembly 100. When upper platform assembly 100 is moved up or down, the spring tension weight balancer 40 correspondingly retracts or releases the riser cable 41. In effect, the counterbalance mechanism permits the cutting mechanism carried by upper platform 1 to be easily docked with the rim of a can to be opened, but without lodging the weight of the upper platform assembly against the can. Upper platform assembly 100 may be considered as having an almost weightless condition where a given position on column 24 will hold constant in the absence of any external force other than gravity, but where a small upward or downward force will urge the assembly upwardly or downwardly to another position on the column which will hold constant as soon as the force is released. The weight of the upper platform assembly is thus considered to be neutralized.

The counterbalance mechanism makes it easier for an operator to open large numbers of large size, heavy cans. Further, it serves to reduce wear and tear on the cutting mechanism. In this regard, it will be understood that if the weight of upper platform assembly 100 was not neutralized then substantially the full weight of the platform would bear down on the can during a can opening operation. The forces generated by this weight would be transmitted through the can opening mechanism.

Generally, it should be noted that weight balancing mechanisms are well known and commercially available. For example, they are often used for adjustable height light fittings and may employ ratchet, friction mechanisms, etc. to enable adjustment for the weight of the item to be held. Accordingly, the details of such mechanisms are not disussed here.

To use the apparatus shown, hold handle 42 and lift upper platform 1 to a height about the same as the can to be opened. Position the can in the center of the platform 28 using keeper 31 as a guide. Push the can into and against the keeper 31. Then, lower upper platform assembly 100 until the can rim 16 is located between traction wheel 6 and cutting blade 11. The rotatable rollers 10 and raised ridges 38 will hold the top and bottom of the can, while the can body is held by keeper 31 from the side. Then, rotate lever handle 21 downwardly to firmly clamp can rim 16 between traction wheel 6 and cutting blade 111 with the cutting edge of blade 11 cutting into the outer seam wall of the rim. At this stage, the can is now in a position to be opened, and motor 4 is turned on to begin the process.

When motor 4 is turned on, traction wheel 6 rotates and can 14 begins to turn. Initially, an effect of cutting angle α will be to pull or lead upper platform assembly 100 downwardly until transverse teeth 8 of traction wheel 6 touch the top of can rim 16. At this point, can 14 receives a full traction force from both longitudinal teeth 9 and transverse teeth 8. As traction wheel 6 turns the can, cutting blade 11 cuts the outer seam wall of can rim 16 and pushes the cut-off upper part of the rim 16 upwardly to separate it from the remainder of the can.

After the can completes one cycle of rotation, the upper part of the can rim will be separated and the procedure will be complete.

Several advantages are inherent in the foregoing embodiment. These include:

(1) In applying traction force to both top and side surfaces of a can's rim, traction wheel 6 is well adapted to handle large sized, heavy cans.

(2) The clamping characteristics of traction wheel 6 and cutting blade 11 combined with the holding characteristics of elements such as rollers 10, locating keeper 31 and raised ridges 38 serve to enhance the stability of the can as it is being cut, and to reduce the likelihood of any unexpected movement during the cutting process. In turn, this reduces wear and tear on the cutting blade, and the possibility of breakage.

(3) The strong traction provided by traction wheel 6 enables a relatively large cutting angle α. Consequently, the ability of cutting blade 11 to push or separate a can's rim from the remainder of the can is enhanced.

(4) The can holding arrangement and counterbalance mechanism serves to minimize friction between upper platform assembly 100 and a can as the can turns while being opened. Specifically, rollers 10 serve to minimize friction on the top of can rim 16. The tangential contact between locating keeper 31 and the side of the can serves to minimize friction on the side. Raised ridges 38 serve to minimize friction on the bottom of the can. Concurrently, the counterbalance mechanism serves to minimize the effective weight of upper platform assembly 100 on the top of a can, and thus reduces the weight factor to the extent that it contributes to friction while the can is turning. The result is increased power for turning the can, reduced likelihood of jamming, and reduced wear and tear on traction wheel 6 and cutting blade 11.

(5) The can holding mechanism enables an operator to easily and quickly place a can in position to be opened, and to remove the can when it has been opened. Further, by reason of the counterbalance mechanism the operator of the apparatus is not burdened by the full weight of upper platform assembly 100 when moving the assembly up or down on guide column 24. Nor is an operator required to carry any weight while a can is being opened. Hence, the apparatus is well adapted for continuous operation in a commercial or institutional setting.

Those skilled in the art will understand that various alterations and modifications are possible in the practice of the invention without departing from the spirit or scope thereof. Accordingly, the scope of the invention is to be construed in accordance with the substance defined by the claims that follow.

I claim:

1. Apparatus for opening a can, said apparatus comprising:
(a) an upwardly extending guide column;
(b) an upper platform assembly, said assembly comprising:
(i) an upper platform slidably mounted to said column for guided movement along said column; and,
(ii) a cutting mechanism carried by said upper platform for opening said can when said can is aligned beneath said upper platform in a can opening position, said cutting mechanism comprising a rotatable circular cutting blade for cutting a seam wall of a rim of said can, and a rotatable traction wheel; and,
(c) a counterbalance mechanism connected to said upper platform for neutralizing the weight of said upper platform assembly.

2. Apparatus as defined in claim 1, wherein said cutting blade is positioned to cut an outer seam wall of said rim, and wherein said traction wheel includes teeth for applying traction to both top and side surfaces of said rim.

3. Apparatus as defined in claim 2, wherein said the plane of rotation of said cutting blade is tilted with respect to the plane of rotation of said traction wheel to define a cutting angle.

4. Apparatus as defined in claim 3, wherein said cutting angle is in the range of 13 to 15 degrees.

5. Apparatus as defined in claim 1, wherein said counterbalance mechanism comprises a spring tension weight balancer attached to said upper platform and a retractable riser cable extending upwardly from said balancer to a fixed hanger.

6. Apparatus for opening a can, said apparatus comprising:
(a) a guide column extending upwardly from a lower platform;
(b) an upper platform assembly, said assembly comprising:
(i) an upper platform slidably mounted to said column for guided movement along said column; and,
(ii) a cutting mechanism carried by said upper platform for opening said can when said can is aligned beneath said upper platform in a can opening position, said cutting mechanism comprising a rotatable circular cutting blade for cutting a seam wall of a rim of said can, and a rotatable traction wheel; and,
(c) a counterbalance mechanism connected to said upper platform for neutralizing the weight of said upper platform assembly.

7. Apparatus as defined in claim 6, wherein said lower platform includes ridges on an upper surface of said lower platform for holding the bottom of said can.

8. Apparatus as defined in claim 7, further including rotatable rollers mounted on the bottom of said upper platform for holding the top of said can.

9. Apparatus as defined in claim 8, further including a locating keeper extending above said lower platform for holding said can from a side of said can.

10. Apparatus as defined in claim 6, wherein said counterbalance mechanism comprises a spring tension weight balancer attached to said upper platform and a retractable riser cable extending upwardly from said balancer to a fixed hanger.

11. Apparatus as defined in claim 10, wherein said cutting blade is positioned to cut an outer seam wall of said rim, and wherein said traction wheel includes teeth for applying traction to both top and side surfaces of said rim.

12. Apparatus as defined in claim 11, wherein said the plane of rotation of said cutting blade is tilted with respect to the plane of rotation of said traction wheel to define a cutting angle.

13. Apparatus as defined in claim 3, wherein said cutting angle is in the range of 13 to 15 degrees.
